(19) United States
(12) Patent Application Publication
(10) Pub. No.: US 2022/0393393 A1
(43) Pub. Date: Dec. 8, 2022

(54) POWER ADAPTER

(71) Applicant: GUANGDONG GOPOD GROUP HOLDING CO., LTD, Shenzhen,Guangdong (CN)

(72) Inventor: Zhuowen Liao, Shenzhen, Guangdong (CN)

(21) Appl. No.: 17/773,458

(22) PCT Filed: Aug. 10, 2020
(86) PCT No.: PCT/CN2020/108219

§ 371 Date: Apr. 29, 2022

(51) Int. Cl. H01R 13/60; H01R 13/629; H01R 13/518

(52) U.S. Cl. CPC H01R 13/60; H01R 13/629; H01R 13/518

(57) ABSTRACT

A power adapter, comprising a power supply body and an adapter mechanism. The power supply body comprises a housing, a first plug and a first plugging structure, wherein the housing has a first mounting surface and a second mounting surface that are provided at an included angle, the first plugging structure is provided on the first mounting surface, and the first plug is connected to the housing; and the adapter mechanism comprises a plug seat, a second plug and a second plugging structure that is pluggable into the first plugging structure, wherein the plug seat has a third mounting surface and an attachment surface, the second plug is provided on the third mounting surface, and the second plugging structure is provided on the attachment surface. The plugging direction of the power adapter can be changed by mounting the adapter mechanism.

### TECHNICAL FIELD

The present application relates to the technical field of electronic devices, and in particular to a power adapter.

### BACKGROUND ART

A power adapter is a power supply transformation device suitable for an electronic device. The power adapter generally comprises a housing and a power plug provided outside the housing as a power input.

The power plug of the power adapter is generally fixed in orientation and can only be adapted to being plugged into a socket in a specific direction. When a plugging direction of the socket is changed or a plugging space is insufficient, the shape or weight of the housing may hinder re-plugging of the power adapter into the socket, thus resulting in a must to be replaced with another power adapter that meets the requirement for the plugging direction, and also causing poor applicability and inconvenience to a user in use.

### SUMMARY OF THE INVENTION

An objective of the present application is to provide a power adapter, which aims to solve the technical problem that a plugging direction of a current power adapter cannot be changed, causing inconvenience to a user in use.

The present application is implemented by a power adapter, which comprises:

a power supply body comprising a housing, a first plug and a first plugging structure, wherein the housing has a first mounting surface and a second mounting surface, the first mounting surface and the second mounting surface are provided at an included angle, the first plugging structure is provided on the first mounting surface, the first plug is connected to the first mounting surface, and the first plug can extend away from the first mounting surface to be plugged into an external socket; and

an adapter mechanism comprising a plug seat, a second plug and a second plugging structure that is pluggable into the first plugging structure, wherein the plug seat has a third mounting surface and an attachment surface that face away from each other, the second plug is provided on the third mounting surface, the second plugging structure is provided on the attachment surface, when the second plugging structure is pluggable into the first plugging structure, the attachment surface is attachable to the second mounting surface, and the second plug is electrically connected to the first plug and capable of extending away from the second mounting surface to be plugged into the external socket.

The first plug is rotatably connected to the first mounting surface and is rotatably switchable between a first plugging position and a first receiving position, and the first plug extends away from the first mounting surface when in the first plugging position and is plugged into the second plugging structure when in the first receiving position.

In one of the embodiments, the second plug is rotatably connected to the third mounting surface and is rotatably switchable between a second plugging position and a second receiving position, and the second plug extends away from the third mounting surface when in the second plugging position and is pluggable into the external socket when in the second receiving position.

In one of the embodiments, the first plugging structure comprises an accommodating slot formed in the first mounting surface and penetrating to the second mounting surface, the second plugging structure comprises a plugging block, and when the first plug is in the first receiving position, the first plug is accommodated in the accommodating slot, and the plugging block is pluggable with the accommodating slot and the first plug.

In one of the embodiments, two accommodating slots are provided, the first plug comprises two first pins, one of the first pins is rotatably connected to a slot wall of one of the accommodating slots, and when the first plug is in the first receiving position, the two first pins are respectively received in the two accommodating slots.

In one of the embodiments, two plugging blocks are provided, and one of the plugging blocks is plugged with one of the accommodating slots and one of the first pins.

In one of the embodiments, the end surface of the end of the plugging block away from the plug seat is provided with a plugging slot, and when the first plug is in the first receiving position and the plugging block is plugged into the accommodating slot, the first pin is plugged into the plugging slot and is electrically connected to the second plug.

In one of the embodiments, the accommodating slot is provided with a first sliding joint structure on a slot wall thereof, the first sliding joint structure extends in an extending direction of the accommodating slot, the plugging block is provided with a second sliding joint structure capable of being in sliding fit with the first sliding joint structure, and when the second sliding joint structure is slidingly connected on the first sliding joint structure, the plugging block is plugged into the accommodating slot.

In one of the embodiments, the first sliding joint structure is a sliding slot formed in the slot wall of the accommodating slot, and the second sliding joint structure is a sliding joint block protruding from a side wall of the plugging block.

In one of the embodiments, the adapter mechanism further comprises a limiting plate connected to the attachment surface, the second plugging structure is connected to the limiting plate, and the limiting plate can be attached to the first mounting surface when the second plugging structure is plugged into the first plugging structure.

In one of the embodiments, the adapter mechanism further comprises a clamping block provided on the side of the limiting plate facing the second plugging structure, and when the second plugging structure is plugged into the first plugging structure, the clamping block is clamped to the housing.

In one of the embodiments, the first mounting surface is provided with a clamping slot, and when the second plugging structure is plugged into the first plugging structure, the clamping block is clamped into the clamping slot.

In one of the embodiments, the second plug comprises two second pins, and the third mounting surface of the plug seat is provided with the one first plugging structure.

In one of the embodiments, the power adapter comprises a plurality of adapter mechanisms.

In one of the embodiments, the power adapter further comprises a plurality of interface seats for plugging external connectors, and the housing is provided with interface holes corresponding to the interface seats.

Compared with the prior art, the present application has the technical effects that the adapter mechanism of the power adapter can achieve the connection with the power supply body by means of the plugging fit between the first plugging structure and the second plugging structure, in this case, the second plug is electrically connected to the first plug, and the power adapter is switched from plugging into the external socket by means of the first plug to plugging into the external socket by means of the second plug; a plugging direction of the first plug faces away from the first mounting surface, a plugging direction of the second plug faces away from the third mounting surface, the attachment surface facing away from the third mounting surface is attached to the second mounting surface, the first mounting surface and the second mounting surface are provided at an included angle, and therefore, the plugging direction of the second plug and the plugging direction of the first plug are provided at an included angle, so that a plugging direction of the power supply body is changed by mounting the adapter mechanisms without replacing the power adapter again; when the power adapter is plugged into the external socket, whether to mount the adapter mechanism may be selected according to the requirements for the plugging direction and space; and the power adapter has good applicability and is convenient for a user to carry.

### BRIEF DESCRIPTION OF THE DRAWINGS

In order to explain the technical solutions of the embodiments of the present application more clearly, the drawings used in the embodiments of the present application or the description of the prior art will be briefly introduced below. Obviously, the drawings described below are only some embodiments of the present application, and for those of ordinary skill in the art, other drawings can be obtained based on these drawings without involving any inventive effort.

FIG. 1 is a perspective structural diagram of a power adapter provided by an embodiment of the present application;

FIG. 2 is an exploded view of the power adapter in FIG. 1;

FIG. 3 is a cross-sectional view of the power adapter in FIG. 1; and

FIG. 4 is an exploded view of an adapter mechanism provided by an embodiment of the present application.

### LIST OF REFERENCE NUMERALS

10. Power supply body; 101. First mounting surface; 102. Second mounting surface; 103. Interface hole; 11. Housing; 12. First plug; 13. First plugging structure; 14. First sliding joint structure; 15. Clamping slot; 20. Adapter mechanism; 21. Plug seat; 211. Third mounting surface; 212. Attachment surface; 22. Second plug; 221. Second pin; 23. Second plugging structure; 231. Plugging slot; 24. Elastic piece; 25. Limiting plate; 26. Second sliding joint structure.

### DETAILED DESCRIPTION OF EMBODIMENTS

Embodiments of the present application will be described below in detail, and examples of the embodiments are shown in the drawings, wherein the same or similar reference numerals represent the same or similar elements or elements having the same or similar functions throughout. The embodiments described below with reference to the accompanying drawings are exemplary and are intended to be illustrative of the present application, and will not be interpreted as limiting the present application.

In the description of the present application, it should be understood that the orientations or positional relationships indicated by the terms “length”, “width”, “vertical”, “horizontal”, “inner”, “outer”, etc. are based on the orientations or positional relationships shown in the drawings, and are only for the convenience of describing the present application and simplifying the description, rather than indicating or implying that the device or element referred to must have a specific orientation or be constructed and operated in a specific orientation, and therefore cannot be construed as limiting the present application.

In addition, the terms “first” and “second” are used for descriptive purposes only, and cannot be construed as indicating or implying relative importance or implicitly indicating the number of technical features indicated. Thus, the features defined with “first” and “second” can explicitly or implicitly include one or more of the features. In the description of the present application, the meaning of “a plurality of” is two or more, unless otherwise explicitly and specifically defined.

In the present application, unless otherwise explicitly specified and limited, the terms such as “mount”, “connect with”, “connect” and “fix” should be broadly understood, for example, they can be a fixed connection or a detachable connection or be integrated; can be a mechanical connection or an electrical connection; and can be directly connected with each other, or can be indirectly connected with each other through an intermediate medium, and can be communication between interiors of two elements or interaction between two elements. For those of ordinary skill in the art, the specific meanings of the above terms in the present application can be understood according to specific situations.

In order to make the object, technical solutions, and advantages of the present application clearer, the present application is described in further detail below with reference to the drawings and embodiments.

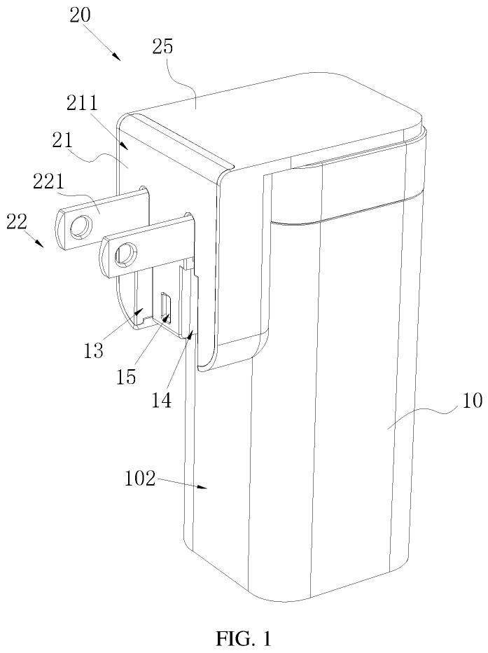

Referring to FIG. 1, the present application provides a power adapter, comprising a power supply body 10 and an adapter mechanism 20.

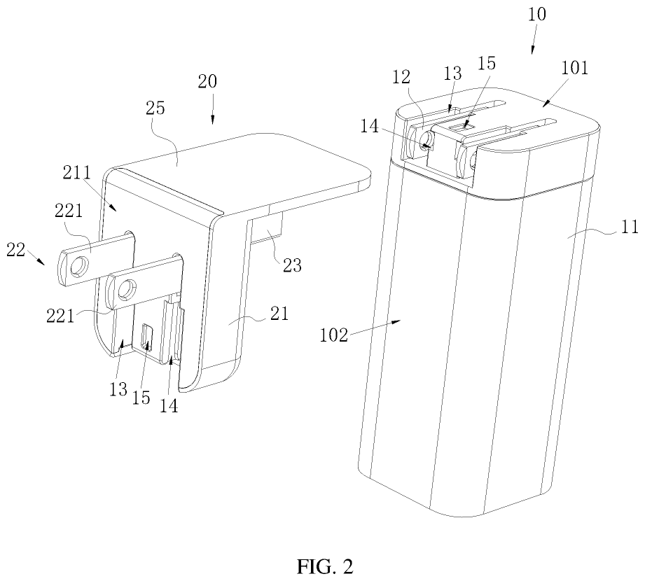

Referring to FIG. 2, the power supply body 10 comprises a housing 11, a first plug 12 and a first plugging structure 13, wherein the housing 11 has a first mounting surface 101 and a second mounting surface 102, and the first mounting surface 101 and the second mounting surface 102 are provided at an included angle. In this embodiment, the housing 11 is a cuboid, the first mounting surface 101 is adjacent to the second mounting surface 102, and the included angle thereof is 90°. The first plugging structure 13 is provided on the first mounting surface 101, the first plug 12 is connected to the housing 11, and the first plug 12 can extend away from the first mounting surface 101 to be plugged into an external socket. When the first plug 12 is plugged into the external socket, the first mounting surface 101 may be attached to an end surface of the external socket provided with a plug jack.

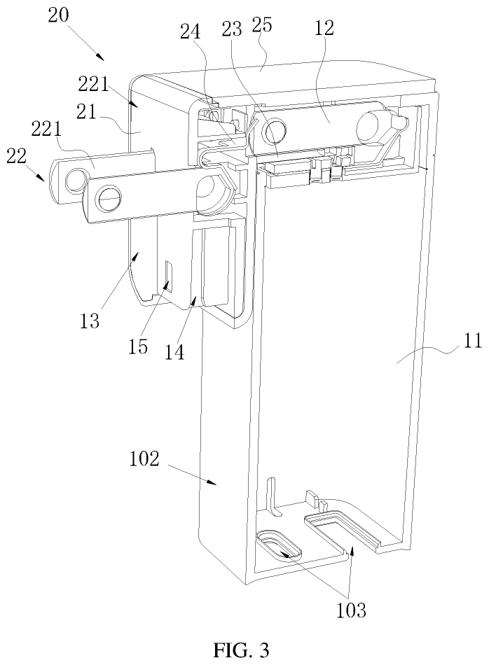

Referring to FIGS. 2 and 3, in particular, to facilitate receiving, the first plug 12 is rotatably connected to the first mounting surface 101 and is rotatably switchable between a first plugging position and a first receiving position, and the first plug 12 extends away from the first mounting surface 101 when in the first plugging position, and is plugged into the second plugging structure 23 when in the first receiving position. That is to say, when in use, the first plug 12 is rotatably switchable from the first receiving position to the first plugging position, and an extending direction of the first plug 12 forms an included angle of 90° with the first mounting surface 101 in this case, and when not in use, the first plug 12 is rotatably switchable from the first plugging position to the first receiving position so as to save space. In this embodiment, when in the first receiving position, the extending direction of the first plug 12 is parallel to the first mounting surface 101. The first plug 12 is rotated in a damping manner during the rotation, or has stop points in both the first receiving position and the first plugging position such that the first plug 12 does not shake without an external force.

A circuit board and other electronic elements connected to the circuit board are provided in the housing 11, and in order to achieve the connection between the power adapter and other electronic devices or connecting wires, the power adapter further comprises a plurality of interface seats for plugging in external connectors, and the interface seats are electrically connected to the circuit board; referring to FIG. 3, the housing 11 is provided with interface holes 103 corresponding to the interface seats. The connectors of the external electronic devices or connecting wires can be in plugging fit with the interface seats through the interface holes 103 to enable electrical connection between the power adapter and the external electronic devices or connecting wires. The number and type of interface seats may be set according to requirements, and in the embodiment of the present application, the interface seat may be one of a USB-Type-C interface seat, a USB-Type-B interface seat, a TF card interface seat, an audio interface seat and an HDMI interface seat to meet the requirements of different plugs.

Referring to FIGS. 1 and 2, the adapter mechanism 20 comprises a plug seat 21, a second plug 22 and a second plugging structure 23 pluggable into the first plugging structure 13, wherein the plug seat 21 has a third mounting surface 211 and an attachment surface 212 that face away from each other, and the first mounting surface 101 and the attachment surface 212 may be substantially parallel to each other. The second plug 22 is provided on the third mounting surface 211, the second plugging structure 23 is provided on the attachment face 212, and when the second plugging structure 23 can be plugged into the first plugging structure 13, the attachment surface 212 can be attached to the second mounting surface 102, and the second plug 22 is electrically connected to the first plug 12 and can extend away from the second mounting surface 102 to be plugged into the external socket. That is to say, an extending direction of the second plug 22 can form an included angle of 90° with the third mounting surface 211 to enable plugging into the external socket. The attachment surface 212 plays a positioning role on the second plug 22 by means of the attachment to the second mounting surface 102.

The second plug 22 is rotatably connected to the third mounting surface 211 and is rotatably switchable between a second plugging position and a second receiving position, and the second plug 22 extends away from the third mounting surface 211 when in the second plugging position and can be plugged into the external socket when in the second receiving position. That is to say, when in use, the second plug 22 is rotatably switchable from the second receiving position to the second plugging position, the extending direction of the second plug 22 forms an included angle of 90° with the third mounting surface 211 in this case, and when not in use, the second plug 22 is rotatably switchable from the second plugging position to the second receiving position so as to save space. In this embodiment, when the second plug 22 is in the second receiving position, the extending direction of the second plug is parallel to the second mounting surface 102. The second plug 22 is rotated in a damping manner during the rotation, or has stop points in both the second receiving position and the second plugging position such that the second plug 22 does not shake without an external force. Preferably, the second plugging structure 23 can be plugged into the first plugging structure 13 and into the first plug 12 when the first plug 12 is in the first receiving position, so as to prevent the first plug 12 from taking up space, and also to play a protective role on the first plug 12.

Referring to FIG. 2, in the illustrated embodiment, the first mounting surface 101 is an end surface having a small area, and the second mounting surface 102 is relatively long. When a plug jack direction of the socket is a horizontal direction, namely, the socket is taken on a vertical surface, if the power supply body is plugged into the socket by means of the first plug 12, the weight of the housing 11 itself is applied to the first plug 12, causing the first plug 12 to be detached from a plug jack of the socket; if the adapter mechanism 20 is mounted on the power supply body, the power adapter can be plugged into the socket with the plug jack facing the horizontal direction in this case so as to prevent the power adapter from being detached from the socket due to its own weight.

The adapter mechanism 20 of the power adapter can achieve the connection with the power supply body by means of the plugging fit between the first plugging structure 13 and the second plugging structure 23, in this case, the second plug 22 is electrically connected to the first plug 12, and the power adapter is switched from plugging into the external socket by means of the first plug 12 to plugging into the external socket by means of the second plug 22; a plugging direction of the first plug 12 faces away from the first mounting surface 101, a plugging direction of the second plug 22 faces away from the third mounting surface 211, the attachment surface 212 facing away from the third mounting surface 211 is attached to the second mounting surface 102, the first mounting surface 101 and the second mounting surface 102 are provided at an included angle, and therefore, the plugging direction of the second plug 22 and the plugging direction of the first plug 12 are provided at an included angle, so that a plugging direction of the power supply body 10 is changed by mounting the adapter mechanisms 20 without replacing the power adapter again; when the power adapter is plugged into the external socket, whether to mount the adapter mechanism 20 may be selected according to the requirements for the plugging direction and space; and the power adapter has good applicability and is convenient for a user to carry.

Referring to FIG. 2, in this embodiment, the first plugging structure 13 comprises an accommodating slot formed in the first mounting surface 101 and penetrating to the second mounting surface 102, and the second plugging structure 23 comprises a plugging block. When the first plug 12 is in the first receiving position, the first plug 12 is accommodated in the accommodating slot, and the plugging block can be plugged with the accommodating slot and the first plug 12, and the first plug 12 plays a limiting role on the plugging block, preventing the plugging block from dropping from an opening of the accommodating slot. In this way, plugging of the first plugging structure 13 and the second plugging structure 23 is achieved. The accommodating slot is used for accommodating the first plug 12 to save space. The plugging block protrudes from the attachment surface 212. In other embodiments, the first plugging structure 13 may also be a plugging block, and the second plugging structure 23 may also be an accommodating slot.

The first plug 12 may be a two-phase or three-phase plug, and when the first plug 12 is the two-phase plug, the first plug 12 comprises two first pins, and the two first pins may be corotated and parallel to each other. Correspondingly, two accommodating slots are provided and the two accommodating slots are spaced apart from each other, a first pin is rotatably connected to a slot wall of one accommodating slot, and when the first plug 12 is in the first receiving position, two first pins are respectively received in the two accommodating slots. When the first plug 12 is in the first plugging position, the two first pins are both perpendicular to the first mounting surface 101. The second plug 22 may be a two-phase or three-phase plug, and when the second plug 22 is the two-phase plug, specifically, the second plug 22 comprises two second pins 221, and the two second pins 221 may be corotated and parallel to each other.

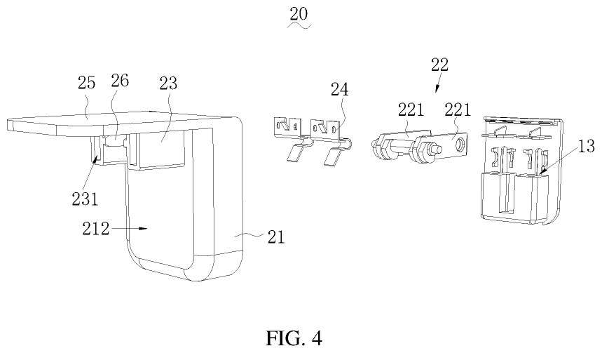

Referring to FIG. 4, correspondingly, two plugging blocks are provided, and one plugging block is plugged with one accommodating slot and one first pin. The two plugging blocks are respectively plugged with two accommodating slots and two first pins, such that the connection between the adapter mechanism 20 and the adapter mechanism 20 is tighter and more stable, further preventing the shaking of the adapter mechanism 20.

Referring to FIG. 4, in order to achieve the plugging fit between the plugging blocks and the first pins, the end surface of the end of the plugging block away from the plug seat 21 is provided with a plugging slot 231, and when the first plug 12 is in the first receiving position and the plugging block is plugged into the accommodating slot, the first pin is plugged into the plugging slot 231 and is electrically connected to the second plug 22. An elastic piece 24 electrically connected to the second plug 22 is provided in the plug seat 21, and the elastic piece 24 extends into the plugging slot 231, and can elastically abut against the elastic piece 24 when the second plug 22 is plugged into the plugging slot 231, so as to electrically connect the first plug 12 and the second plug 22. The plugging slot 231 plays protective and limiting roles on the second pin 221, and the attachment surface 212 and the plugging slot 231 can jointly limit the separation of the plugging block from the second pin 221.

Referring to FIGS. 2 and 3, in order to facilitate the plugging fit between the plugging block and the accommodating slot, the accommodating slot is provided with a first sliding joint structure 14 on the slot wall thereof, the first sliding joint structure 14 extends in an extending direction of the accommodating slot, the plugging block is provided with a second sliding joint structure capable of being in sliding fit with the first sliding joint structure 14, and when the second sliding joint structure is slidingly connected on the first sliding joint structure 14, the plugging block is plugged into the accommodating slot. The first sliding joint structure 14 can limit the movement of the plugging block in a forming direction of the accommodating slot to improve the stability of connection.

Referring to FIGS. 2 and 4, in this embodiment, the first sliding joint structure 14 is a sliding slot formed in the slot wall of the accommodating slot, and the second sliding joint structure is a sliding joint block protruding from a side wall of the plugging block. The sliding slot plays guiding and limiting roles for the sliding joint block. The sliding joint block is elongated and extends in a forming direction of the plugging slot 231, and the sliding slot is formed in the slot wall of one accommodating slot close to the other accommodating slot. In other embodiments, the first sliding joint structure 14 may also be a sliding joint block protruding from the side wall of the plugging block, and the second sliding joint structure may also be a sliding slot formed in the slot wall of the accommodating slot.

Referring to FIGS. 2 and 3, in order to limit the separation of the adapter mechanism 20 from the power supply body, the adapter mechanism 20 further comprises a limiting plate 25 connected to the attachment surface 212, the limiting plate 25 protrudes from the attachment surface 212 and extends in the same direction as the plugging block, the second plugging structure 23 is connected to the limiting plate 25, and the limiting plate 25 can be attached to the first mounting surface 101 when the second plugging structure 23 is plugged into the first plugging structure 13. During mounting, the side surface of the limiting plate 25 facing the second plugging structure 23 is firstly attached to the first mounting surface 101, and the plug seat 21 is then pushed toward the second mounting surface 102 until the attachment face 212 is attached to the second mounting surface 102, and in this case, the second plugging structure 23 can be adaptively plugged into the first plugging structure 13, making assembly quick and convenient. The limiting plate 25 and the attachment surface 212 can jointly limit the shaking and displacement of the adapter mechanism 20 relative to the power supply body.

In order to further prevent the adapter mechanism 20 from being separated from the power supply body in the direction away from a mounting direction, the adapter mechanism 20 further comprises a clamping block provided on the side of the limiting plate 25 facing the second plugging structure 23, and when the second plugging structure 23 is plugged into the first plugging structure 13, the clamping block is clamped to the housing 11. The clamping block protrudes from the first mounting surface 101, and when the second plugging structure 23 is plugged into the first plugging structure 13, the limiting plate 25 may tightly abut against the clamping block by means of slight elastic deformation, thus increasing a friction force between the limiting plate 25 and the power supply body.

Referring to FIG. 2, in order to achieve the clamping connection between the clamping block and the housing 11, the first mounting surface 101 is provided with a clamping slot 15, and when the second plugging structure 23 is plugged into the first plugging structure 13, the clamping block is clamped into the clamping slot 15. The clamping slot 15 plays positioning and limiting roles on the clamping block, and in the absence of an external force, the clamping fit between the clamping block and the clamping slot 15 limits the separation of the adapter mechanism 20 from the power supply body. When the adapter mechanism 20 is pushed by an external force, the limiting plate 25 causes the clamping block to slip out of the clamping slot 15 by means of slight elastic deformation, thereby separating the adapter mechanism 20 from the power supply body.

Referring to FIGS. 1 to 3, the plug seat 21 is preferably provided with a first plugging structure 13 on its third mounting surface 211. In this way, the plugging structure can be in plugging fit with a further external component having the second plugging structure 23 to achieve adapting. Specifically, the plug seat 21 is further provided with a clamping slot 15 for sliding joint with a further external component having the clamping block. The slot wall of the accommodating slot on the plug seat 21 is also provided with the first sliding joint structure 14 for sliding joint with a further external component having the second sliding joint structure.

In order to improve the applicability of the power adapter, the power adapter may comprise a plurality of adapter mechanisms 20. The second plugs 22 on the adapter mechanisms 20 may be plugs of different specifications, such as plugs conforming to the British, European, or American standards, which can be replaced or assembled as desired by a user. The adapter mechanisms 20 may further be plugged in sequence.

The above embodiments are merely preferred embodiments of the present application, only the technical principles of the present application are specifically described, and these descriptions are only for explaining the principles of the present application and cannot be interpreted in any way as limiting the scope of protection of the present application. Based on the explanation herein, any modifications, equivalent replacements, and improvements made within the spirit and principles of the present application, and other specific implementations of the present application conceived by those skilled in the art without involving any inventive effort should be included within the scope of protection of the present application.

1. A power adapter, comprising:
a power supply body comprising a housing, a first plug and a first plugging structure, wherein the housing has a first mounting surface and a second mounting surface, the first mounting surface and the second mounting surface are provided at an included angle, the first plugging structure is provided on the first mounting surface, the first plug is connected to the housing, and the first plug can extend away from the first mounting surface to be plugged into an external socket; and
an adapter mechanism comprising a plug seat, a second plug and a second plugging structure that is pluggable into the first plugging structure, wherein the plug seat has a third mounting surface and an attachment surface that face away from each other, the second plug is provided on the third mounting surface, the second plugging structure is provided on the attachment surface, when the second plugging structure is pluggable into the first plugging structure, the attachment surface is attachable to the second mounting surface, and the second plug is electrically connected to the first plug and capable of extending away from the second mounting surface to be plugged into the external socket.

2. The power adapter of claim 1, wherein the first plug is rotatably connected to the first mounting surface and is rotatably switchable between a first plugging position and a first receiving position, and the first plug extends away from the first mounting surface when in the first plugging position and is plugged into the second plugging structure when in the first receiving position.

3. The power adapter of claim 1, wherein the second plug is rotatably connected to the third mounting surface and is rotatably switchable between a second plugging position and a second receiving position, and the second plug extends away from the third mounting surface when in the second plugging position and is pluggable into the external socket when in the second receiving position.

4. The power adapter of claim 2, wherein the first plugging structure comprises an accommodating slot formed in the first mounting surface and penetrating to the second mounting surface, the second plugging structure comprises a plugging block, and when the first plug is in the first receiving position, the first plug is accommodated in the accommodating slot, and the plugging block is pluggable with the accommodating slot and the first plug.

5. The power adapter of claim 4, wherein two accommodating slots are provided, the first plug comprises two first pins, one of the first pins is rotatably connected to a slot wall of one of the accommodating slots, and when the first plug is in the first receiving position, the two first pins are respectively received in the two accommodating slots.

6. The power adapter of claim 5, wherein two plugging blocks are provided, and one of the plugging blocks is plugged with one of the accommodating slots and one of the first pins.

7. The power adapter of claim 6, wherein the end surface of the end of the plugging block away from the plug seat is provided with a plugging slot, and when the first plug is in the first receiving position and the plugging block is plugged into the accommodating slot, the first pin is plugged into the plugging slot and is electrically connected to the second plug.

8. The power adapter of claim 4, wherein the accommodating slot is provided with a first sliding joint structure on a slot wall thereof, the first sliding joint structure extends in an extending direction of the accommodating slot, the plugging block is provided with a second sliding joint structure capable of being in sliding fit with the first sliding joint structure, and when the second sliding joint structure is slidingly connected on the first sliding joint structure, the plugging block is plugged into the accommodating slot.

9. The power adapter of claim 8, wherein the first sliding joint structure is a sliding slot formed in the slot wall of the accommodating slot, and the second sliding joint structure is a sliding joint block protruding from a side wall of the plugging block.

10. The power adapter of claim 1, wherein the adapter mechanism further comprises a limiting plate connected to the attachment surface, the second plugging structure is connected to the limiting plate, and the limiting plate is attachable to the first mounting surface when the second plugging structure is plugged into the first plugging structure.

11. The power adapter of claim 10, wherein the adapter mechanism further comprises a clamping block provided on the side of the limiting plate facing the second plugging structure, and when the second plugging structure is plugged into the first plugging structure, the clamping block is clamped to the housing.

12. The power adapter of claim 11, wherein the first mounting surface is provided with a clamping slot, and when the second plugging structure is plugged into the first plugging structure, the clamping block is clamped into the clamping slot. n

13. The power adapter of claim 1, wherein the second plug comprises two second pins, and the third mounting surface of the plug seat is provided with the one first plugging structure.

14. The power adapter of claim 13, wherein the power adapter comprises a plurality of adapter mechanisms.

15. The power adapter of claim 1, wherein the power adapter further comprises a plurality of interface seats for plugging external connectors, and the housing is provided with interface holes corresponding to the interface seats.
